(19) United States
(12) Patent Application Publication
(10) Pub. No.: US 2017/0130120 A1
(43) Pub. Date: May 11, 2017

(54) Winterized Scale Inhibitor

(71) Applicant: Nachurs Alpine Solutions, Corp., Marion, OH (US)

(72) Inventor: Sanjay Wahal, Appleton, WI (US)

(21) Appl. No.: 15/348,329

(22) Filed: Nov. 10, 2016

Related U.S. Application Data
(60) Provisional application No. 62/253,620, filed on Nov. 10, 2015.

(51) Int. Cl. C09K 8/528

(52) U.S. Cl. CPC C09K 8/528

(57) ABSTRACT

The invention discloses representative compositions for and methods of effective scale inhibitor treatments at temperatures below about 0° C. The compositions used according to the method function to prevent scale formation over a wide range of temperatures. Further, the compositions are compatible with a broad range of additives.

### CROSS-REFERENCE TO PRIOR APPLICATIONS

The present application claims priority to U.S. Patent Application 62/253,620 filed 2016 Nov. 10, currently pending, which is incorporated by reference in its entirety.

### FIELD OF THE INVENTION

The invention relates to methods and fluids for scale inhibition in drilling wells.

### BACKGROUND OF THE INVENTION

Hydrocarbons (oil, natural gas, etc.) are typically obtained from a subterranean geologic formation by drilling a well that penetrates the hydrocarbon-bearing formation. During recovery of the hydrocarbons, water containing a number of dissolved salts, such as calcium cations and/or carbonate and phosphate anions, is often coproduced with the hydrocarbon. The combination products of calcium cation with carbonate anion or phosphate anion can precipitate from the water in which the ions are carried to form “scale” deposits when the concentrations of these anions and cations exceed the solubility of the reaction product. The formation of scale can slow oil production rate and, in extreme circumstances, stop production completely.

One method of preventing scale deposits from forming is to inject scale inhibitor fluids into the borehole. Scale inhibitor compositions typically comprise from about 20 wt % to about 35 wt % of an active component in an aqueous solution. The aqueous solutions function well in relatively warm weather conditions, but when the borehole temperature drops below freezing the scale inhibitor can no longer be used effectively.

To counteract the effects of freezing temperatures on aqueous solutions, winterized versions of scale inhibitor compositions typically use methanol or ethylene glycol to replace a portion of the water. The methanol or ethylene glycol lowers the freezing point of the aqueous solution and thereby reduces the risk of freezing. However, the concentration of methanol or ethylene glycol that must be added to lower the freezing point below about −20° C. can create solubility problems for the active components of the scale inhibitor compositions. To overcome the solubility problems, the concentration of the active components must be decreased to less than about 20 wt % of the winterized composition, and in some colder environments when more methanol is required, to less than about 10 wt % of the composition. Because of the low actives content, significantly more scale inhibitor must be used in winter temperature conditions than in warmer weather.

### SUMMARY OF THE PRESENT INVENTION

The present development is method of winterizing a scale inhibitor composition by replacing methanol and/or ethylene glycol in the composition with an aqueous potassium acetate solution. The method is intended to produce compositions for use either topside or in boreholes in the oil and gas production industry.

An exemplary winterized scale inhibitor composition using the method of the present development comprises from about 20 wt % to about 35 wt % of an active component, from about 10 wt % to about 25 wt % of potassium acetate, and the balance water. In a more preferred method, the amount of potassium acetate solution added is adequate to depress the freezing point to negative 20° C. or lower. In a first embodiment, the active components are selected from the group consisting of polyacrylic acid derivatives, diethylenetriamine penta(methylene phosphonic acid) (“DETA phosphonate”), and phosphate esters.

### DETAILED DESCRIPTION OF THE PRESENT DEVELOPMENT

The invention discloses representative compositions for and methods of effective scale inhibitor treatments at temperatures below about 0° C. The compositions used according to the method function to prevent scale formation over a wide range of temperatures. Further, the compositions are compatible with a broad range of additives.

It has been unexpectedly discovered that the addition of potassium acetate to an aqueous scale inhibitor composition can depress the freezing point of the composition to below −20° C. without requiring a reduction in the concentration of active components in the composition. An added advantage is that the addition of potassium acetate to the composition does not alter or affect or diminish in any way the efficacy of the scale inhibitor, either when used in an environment having a temperature less than or equal to −20° C. or in an environment having a temperature greater than −20° C.

The potassium acetate concentration may be up to at least 25 wt % of the total weight of fluid. In a preferred embodiment, the potassium acetate should comprise from about 0.1 wt % to about 25 wt % of the total weight of fluid. In a more preferred embodiment, the potassium acetate should comprise from about 10 wt % to about 21 wt % of the total weight of fluid. The potassium acetate may be added as a solid or as an aqueous solution. If the latter, the amount added should be adjusted to compensate for the solvent present. For example, the addition of 24 wt % of a 50% potassium acetate solution would deliver 12 wt % potassium acetate to the total weight of fluid.

Any suitable scale inhibitor may be used according to the invention, as long as it is effective upon being placed in the reservoir zone of interest, and adsorbed onto the formation minerals to help prevent scale deposits from occurring during oil or gas production. Examples of some suitable scale inhibitors include, but are not necessarily limited to compounds selected from the classes of phosphate esters, phosphonates, phosphonate polymers, polycarboxylates, polycarboxylates, phosphorous-containing polycarboxylates, nitrogen-containing phosphonate, acrylic acid, methacrylic acid, maleic acid, itaconic acid, fumaric acid, mesoconic acid, citraconic acid, aminomethylenephosphonates, phosphorus end capped polycarboxylic acid, sulphonated polycarboxylic acid copoloymer, DETA phosphonate, penta-phosphonate, ethylenediaminetetra (methylenephosphonic acid), hexamethylenediaminetetra (methylenephosphonic acid), monoesters of diacids with alkanols, monomeric and polymeric phosphonates, homopolymers and copolymers of vinylphosphonate, organic phosphate esters, hydroxylamine phosphate esters, phosphate esters of polyols and their salts containing one or more 2-hydroxyethyl groups, and combinations thereof. Scale inhibitors may contain one or more carboxylate and/or phosphonate groups capable of interacting with polyvalent metal ions.

Any applicable amount of scale inhibitors may be used. For example, in a preferred embodiment the scale inhibitor comprises up to about 60% by weight of the composition based upon total fluid weight. In a more preferred embodiment, the scale inhibitor comprises from 10% by weight to about 50% by weight based upon total fluid weight, and more preferably from about 20% by weight to about 35% by weight based upon total fluid weight.

Scale inhibitor compositions useful in some embodiments of the invention may further contain other additives and chemicals that are known to be commonly used in oilfield applications by those skilled in the art. These include, but are not necessarily limited to, materials such as surfactants, oxygen scavengers, alcohols, corrosion inhibitors, fluid-loss additives, bactericides, and the like. These may be added as necessary to achieve the scale inhibitor characteristics desired. In a preferred embodiment, the additives comprise up to about 20 wt % of the composition.

Water constitutes the remainder of the composition.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. Thus, for example, reference to “an active component” includes a plurality of such active components, and so forth.

Unless otherwise indicated, all numbers expressing quantities of components, conditions, and otherwise used in the specification and claims should be read once as modified by the term “about” (unless already expressly so modified), and then read again as not so modified unless otherwise indicated in context. Accordingly, unless indicated to the contrary, the numerical parameters set forth in the instant specification and attached claims are approximations that can vary depending upon the desired properties sought to be obtained by the presently disclosed subject matter. Further, it is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that the inventors appreciate and understand that any and all data points within the range are to be considered to have been specified, and that inventors possession of the entire range and all points within the range

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description and drawings, those with ordinary skill in the art will be able to make changes and modifications to the present invention without departing from the spirit or scope of the invention, as defined herein. For example, those skilled in the art may vary the concentration of potassium acetate in the potassium acetate solution, and may compensate for the concentration variation of the starting material by varying the amount used as appropriate to deliver the specified potassium acetate to the final composition.

What is claimed is:

1: A winterized scale inhibitor composition consisting essentially of:
(a) potassium acetate;
(b) a scale inhibitor;
(c) at least one scale inhibitor additive; and,
(d) water.

2: The winterized scale inhibitor of claim 1 wherein the scale inhibitor is selected from the group consisting of phosphate esters, phosphonates, phosphonate polymers, polycarboxylates, polycarboxylates, phosphorous-containing polycarboxylates, nitrogen-containing phosphonate, acrylic acid, methacrylic acid, maleic acid, itaconic acid, fumaric acid, mesoconic acid, citraconic acid, aminomethylenephosphonates, phosphorus end capped polycarboxylic acid, sulphonated polycarboxylic acid copoloymer, DETA phosphonate, penta-phosphonate, ethylenediaminetetra (methylenephosphonic acid), hexamethylenediaminetetra (methylenephosphonic acid), monoesters of diacids with alkanols, monomeric and polymeric phosphonates, homopolymers and copolymers of vinylphosphonate, organic phosphate esters, hydroxylamine phosphate esters, phosphate esters of polyols and their salts containing one or more 2-hydroxyethyl groups, and combinations thereof.

3: The winterized scale inhibitor of claim 1 wherein the scale inhibitor additive is selected from the group consisting of surfactants, oxygen scavengers, alcohols, corrosion inhibitors, fluid-loss additives, bactericides, and combinations thereof.

4: The winterized scale inhibitor of claim 1 wherein the potassium acetate has a concentration of from 0.1 wt % to 25 wt % of the total weight of fluid.

5: The winterized scale inhibitor of claim 4 wherein the potassium acetate has a concentration of from 10 wt % to 21 wt % of the total weight of fluid.

6: The winterized scale inhibitor of claim 1 wherein the potassium acetate is added as a 50 wt % potassium acetate solution.

7: The winterized scale inhibitor of claim 1 wherein the potassium acetate is added as a 60 wt % potassium acetate solution.

8: The winterized scale inhibitor of claim 1 wherein the scale inhibitor has a concentration of from 0 wt % to 60 wt % based upon total fluid weight.

9: The winterized scale inhibitor of claim 8 wherein the scale inhibitor has a concentration of from about 10% by weight to about 35% by weight based upon total fluid weight.

10: The winterized scale inhibitor of claim 1 wherein the scale inhibitor additive has a concentration of up to about 20% by weight based upon total fluid weight.

11: A winterized scale inhibitor composition comprising:
(a) from 0.1 wt % to 25 wt % potassium acetate;
(b) a scale inhibitor, selected from the group consisting of phosphate esters, phosphonates, phosphonate polymers, polycarboxylates, polycarboxylates, phosphorous-containing polycarboxylates, nitrogen-containing phosphonate, acrylic acid, methacrylic acid, maleic acid, itaconic acid, fumaric acid, mesoconic acid, citraconic acid, aminomethylenephosphonates, phosphorus end capped polycarboxylic acid, sulphonated polycarboxylic acid copoloymer, DETA phosphonate, penta-phosphonate, ethylenediaminetetra (methylenephosphonic acid), hexamethylenediaminetetra (methylenephosphonic acid), monoesters of diacids with alkanols, monomeric and polymeric phosphonates, homopolymers and copolymers of vinylphosphonate, organic phosphate esters, hydroxylamine phosphate esters, phosphate esters of polyols and their salts containing one or more 2-hydroxyethyl groups, and combinations thereof;
(c) at least one scale inhibitor additive, selected from the group consisting of surfactants, oxygen scavengers, alcohols, corrosion inhibitors, fluid-loss additives, bactericides, and combinations thereof; and,
(d) water.

12: The winterized scale inhibitor of claim 11 wherein the potassium acetate has a concentration of from 10 wt % to 21 wt % of the total weight of fluid.

13: The winterized scale inhibitor of claim 11 wherein the potassium acetate is added as a 50 wt % potassium acetate solution.

14: The winterized scale inhibitor of claim 11 wherein the potassium acetate is added as a 60 wt % potassium acetate solution.

15: The winterized scale inhibitor of claim 11 wherein the scale inhibitor has a concentration of from 0 wt % to 60 wt % based upon total fluid weight.

16: The winterized scale inhibitor of claim 15 wherein the scale inhibitor has a concentration of from about 10 wt % to about 35 wt % based upon total fluid weight.

17: The winterized scale inhibitor of claim 11 wherein the scale inhibitor additive has a concentration of up to 20 wt % based upon total fluid weight.
